(19) United States
(12) Patent Application Publication
(10) Pub. No.: US 2008/0304226 A1
(43) Pub. Date: Dec. 11, 2008

(54) HARD DISK SECURING MECHANISM

(76) Inventor: CHENG-TSUN LEE, San Chung City (TW)

Correspondence Address: LEONG C LEI, PMB # 1008, 1867 YGNACIO VALLEY ROAD, WALNUT CREEK, CA, 94598, US

(21) Appl. No.: 11/674,681

(22) Filed: Feb. 14, 2007

(51) Int. Cl. G06F 1/16

(52) U.S. Cl. 361/685

(57) ABSTRACT

A hard disk securing mechanism is disclosed. The securing mechanism comprises a securing seat for mounting to the housing of the computer; a plurality of holding members for locking the lateral sides of the hard disk to the securing seat to prevent vibration of the hard disk in operation; and two blocking members mounted at the front end of the securing seat to prevent the hard disk from sliding out.

### BACKGROUND OF THE INVENTION

(a) Technical Field of the Invention

The present invention relates to securing mechanism, and in particular, a securing mechanism for hard disk of a computer, such that the hard disk can be installed conveniently, and vibration and noise of the hard disk in operation is reduced.

(b) Description of the Prior Art

Generally, hard disk common found in computer is directly locked onto the computer casing, and most of the time, no buffering device is provided to the hard disk. When the hard disk is in operation, vibration generally occurs. As a result, when computer is in operation, noise is generated and most of the time, noise irritates the user. This is a drawback of technological advanced product. In addition, loading and unloading of hard disk in the course of maintenance are not convenient and inefficient as the hard disk is directly mounted to the computer casing. In view of the drawbacks mentioned, the conventional securing mechanism of the hard disk needs to be improved.

### SUMMARY OF THE INVENTION

The primary purpose of the present invention is to provide a hard disk securing mechanism for computer, comprising a securing seat for mounting to the housing of the computer; a plurality of holding members for locking the lateral sides of the hard disk to the securing seat to prevent vibration of the hard disk in operation; and two blocking members mounted at the front end of the securing seat to prevent the hard disk from sliding out.

Still a further object of the present invention is to provide a hard disk securing mechanism, wherein the securing seat has a substantially U-shaped, and the vertical face of the securing seat is provided with a through hole proximity to the end of the vertical face, and one end of the horizontal face of the securing seat is a securing hole, the extension of the securing hole is a notch for the mounting of two blocking members.

Yet still a further object of the present invention is to provide a hard disk securing mechanism, wherein the blocking member is a block body with two sloping ends and the upper section of the block body is joined to an engaging section of smaller radius, and the engaging section is joined to an end section of a larger radius.

Another object of the present invention is to provide a hard disk securing mechanism, wherein the holding member is a cylindrical body having a large and a small radius and the center of the cylindrical body is a securing hole for locking onto the hard disk.

Yet a further object of the present invention is to provide a hard disk securing mechanism, wherein the holding member is a cylindrical body having a large and a small radius and the center of the cylindrical body is a securing hole for locking onto the hard disk.

A further object of the present invention is to provide a hard disk securing mechanism, wherein the holding member is made from rubber or resilent material.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a hard disk securing mechanism of the present invention.

FIG. 2 is a perspective exploded view of the hard disk securing mechanism of the present invention.

FIG. 3 is another perspective view of the hard disk securing mechanism of the present invention.

FIG. 4 is a sectional view of the hard disk securing mechanism of the present invention.

FIG. 5 is another exploded perspective view in accordance with a preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

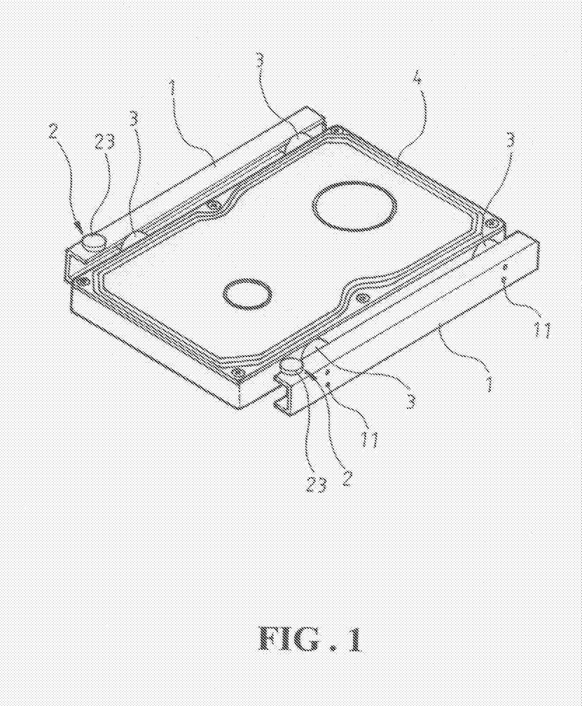

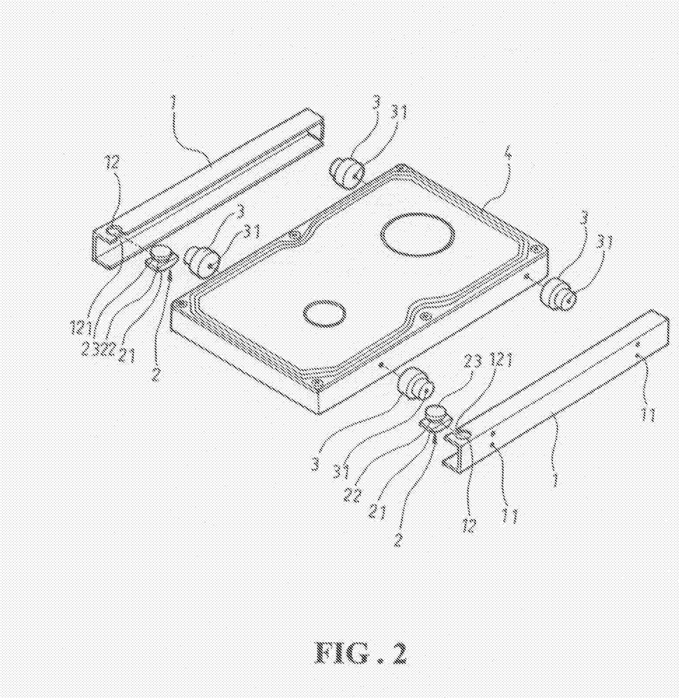

Referring to FIGS. 1 and 2, there is shown a hard disk securing mechanism of the present invention comprising two securing seats 1, two blocking member 2 and a plurality of holding members 3. The shape of the securing seat 1 substantially a U-shaped, and each a through hole 11 is formed on the vertical face of the seat 1 at a position proximity to the ends of the securing seat 1. A securing hole 12 is formed on the horizontal face of the securing seat 1 at one end thereof. The securing hole 12 extended till the edge of the securing seat 1 is a notch 121.

In accordance with the present invention, the blocking member 2 is an element having two sloping block bodies 21. The upper section of the block body 21 is joined to an engaging section 22 of smaller radius, and the engaging section 22 is joined to an end section 23 of larger radius.

The holding member 3 is a cylindrical body formed from a larger and a small radius cylindrical bodies, and the center of the cylindrical body is a securing hole 31. The holding member 3 is made from rubber or other resilent material.

In forming the securing mechanism, the two securing seats 1 are locked or secured to the computer casing (not shown) by way of the through hole 11 provided at the vertical face of the securing seat 1. The holding member 3 is locked to the two lateral sides of the hard disk 4 via the securing hole 31. The holding member 3 after engaging with the securing seat 1, and the two blocking members 2 and inserted into the securing hole 12 of the securing seat 1. This will prevent the hard disk 4 from sliding out. Thus, when the hard disk 4 is in operation, the holding member 3 provide a buffering function, and prevent vibration, and lower noise generation. And, therefore, the loading and unloading of the hard disk are convenient and quick.

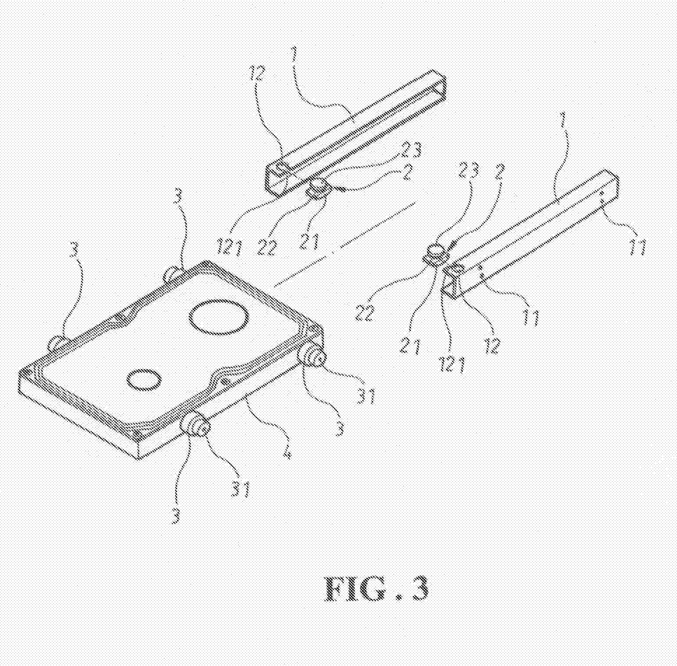

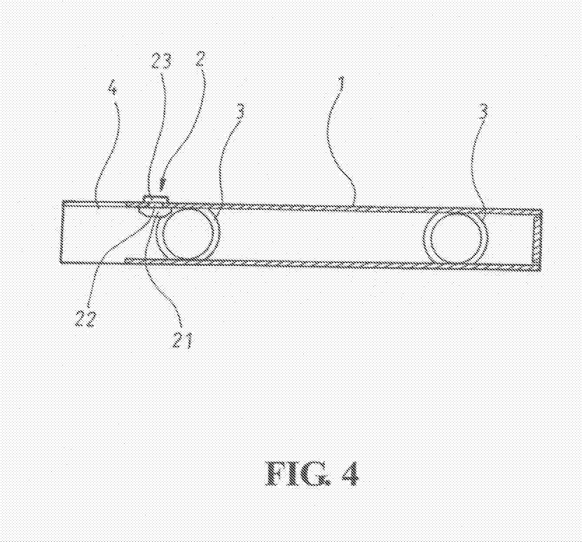

Referring to FIGS. 3 and 4, in combination, the two securing seats 1 are respectively secured to the computer casing via the through hole 11 the vertical face of the securing seat 1. The holding member 3 is then locked to the two lateral sides of the hard disk 4, via the securing hole 31. Thus, the hard disk 4 is slided in by way of the cylindrical body of smaller radius of the holding member 3 from the front section of the securing seat 1. The hard disk 4 is engaged at the securing seat 1. After the hard disk 4 is secured, the engaging section 22 of the blocking member 2 moves along the securing hole 12 to the notch 121, and is then positioned at the securing hole 12. The blockage at the lower section of the block body 21 prevents the hard disk 4 from sliding forward. Thus the hard disk 4, in the course of operation, will be provided with a buffering effect from the holding member 3, and this gives the effect of anti-vibration, and lowering of noise. When the hard disk 4 needs to be repaired or maintained the two blocking members 2 are unloaded from the securing hole 12, and the hard disk 4 is pulled out. The securing mechanism of the present invention provides a rapid loading and unloading operation.

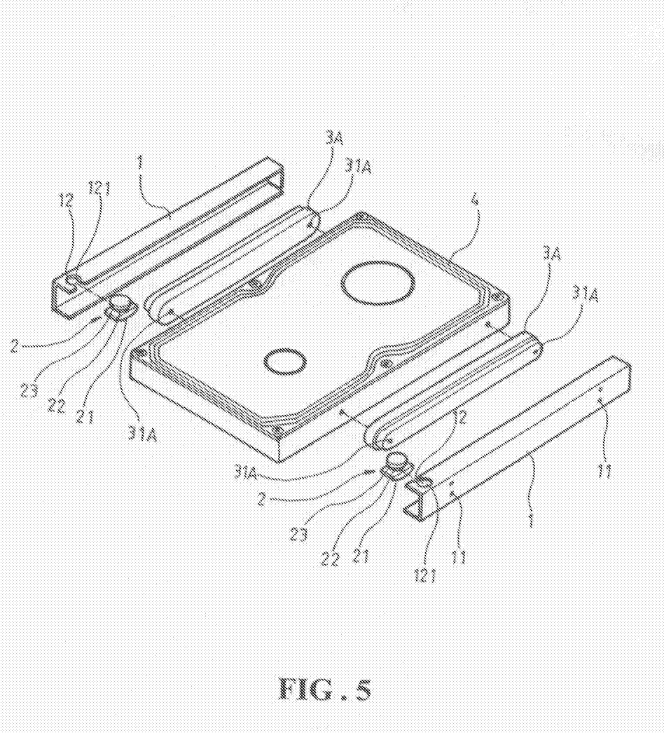

FIG. 5 is another preferred embodiment in accordance with the present invention. The elongated holding members 3A having a high and low step are provided with a securing hole 31A at the end thereof for locking of the hard disk 4. The low step of the holding member 3A slides into the securing seat 1 and engages with the securing seat 1.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hard disk securing mechanism for computer, comprising
a securing seat for mounting to the housing of the computer;
a plurality of holding members for locking the lateral sides of the hard disk to the securing seat to prevent vibration of the hard disk in operation; and
two blocking members mounted at the front end of the securing seat to prevent the hard disk from sliding out.

2. The hard disk of claim 1, wherein the securing seat has a substantially U-shaped, and the vertical face of the securing seat is provided with a through hole proximity to the end of the vertical face, and one end of the horizontal face of the securing seat is a securing hole, the extension of the securing hole is a notch for the mounting of two blocking members.

3. The hard disk of claim 1, wherein the blocking member is a block body with two sloping ends and the upper section of the block body is joined to an engaging section of smaller radius, and the engaging section is joined to an end section of a larger radius.

4. The hard disk of claim 1, wherein the holding member is a cylindrical body having a large and a small radius and the center of the cylindrical body is a securing hole for locking onto the hard disk.

4. The hard disk of claim 1, wherein the holding member is an elongated body having a high and a low step, and the two ends of the elongated body are provided with securing hole for mounting with the hard disk.

5. The hard disk of claim 4 or 5, wherein the holding member is made from rubber or resilent material.
